(19) United States
(12) Patent Application Publication
(10) Pub. No.: US 2002/0154016 A1
(43) Pub. Date: Oct. 24, 2002

(54) Computer system and method for preventing CPU burn-out

(76) Inventor: Ken Wang, Hsinchu Hsien (TW)

Correspondence Address: J.C. Patents, Inc., 4 Venture, Suite 250, Irvine, CA, 92618, US

(21) Appl. No.: 09/990,458

(22) Filed: Nov. 20, 2001

(30) Foreign Application Priority Data
Apr. 23, 2001 (TW) 90109603

(51) Int. Cl. G08B 19/02

(52) U.S. Cl. 340/584; 340/662; 340/521

(57) ABSTRACT

A computer system and method for preventing burnout of a Central Processing Unit (CPU). The computer system includes a CPU, a temperature sensor, a Direct Current to Direct Current (DC-DC) transformer, a hardware monitor and an ATX power supply. The CPU serves to execute computer programs. The temperature sensor is adjacent to or directly attached to the CPU for monitoring the operating temperature of the CPU. The DC-DC transformer is coupled to the CPU for providing CPU source voltage. The hardware monitor is coupled to the temperature sensor and the DC-DC transformer for monitoring the operating temperature and the source voltage of the CPU. The ATX power supply is coupled to the hardware monitor and the DC-DC transformer and controlled by a Post Power-Triggering Signal. When the operating temperature or the source voltage exceeds a permitted range, the hardware monitor sends a Post Power-Triggering signal to the ATX power supply to cut its output power off.

### CROSS-REFERENCE TO RELATED APPLICATION

This application claims the priority benefit of Taiwan application serial no. 90109603, filed Apr. 23, 2001.

### BACKGROUND OF THE INVENTION

1. Field of Invention

The present invention relates to a protective unit for a Central Processing Unit (CPU), especially, preventing CPU from burn-out in a computer system.

2. Description of Related Art

In a conventional computer systemwith a Central Processing Unit (CPU) burned-out protection functionality, operating voltage and temperature of the CPU are constantly monitored by a hardware device to ensure that the voltage and temperature stay in a permissible range. When the system is not operated under a normal condition, the system will issue an interrupt signal the user may be informed through a system interrupt signal issued by the system. Or, the system will activate a protection software program. Thus, the CPU burnout prevention function could be achieved. Referring to FIG. 1, which is a schematic diagram illustrating a conventional computer system withe the CPU burnout protection. The system includes a Direct Current-to-Direct Current (DC-DC) transformer 100, a CPU 110, a hardware monitor 120, an ATX power supply 130, a chipset 140, a temperature sensor 150 and a voltage detector 160.

In the conventional computer system, the chipset 140 generates a power-triggering signal that is sent to the ATX power supply 130. As the ATX power supply 130 receives the power-triggering signal from the chipset 140, the power supply 130 provides a power to both the (DC-DC)transformer 100 and the hardware monitor device 120. The (DC-DC) transformer 100, then, provides a correct source voltage to the CPU 110, The hardware monitor 120 monitors the operating temperature and source voltage of the CPU 110. When the CPU 110 operating temperature, source voltage or both are under abnorml circumstances, i.e. beyond the normal range, a system interrupt signal will be issued to cut the source voltage off. Alternatively, the hardware monitor 120 sends out a signal to the chipset 140 indicating the system under abnormal condition.The chipset 140, then, sends out a system interrupt signal to the CPU 110 and activates a protection software program to alert users. Furthermore, in some cases, the users have to turn the computer system off manually and immediately to protect the CPU 110 from burning out.

However, there are several drawbacks with the aforementioned technique listed as follows:

1. If the users were away from the system, the users would not be aware of that CPU is running under a dangerous condition, either s abnormal operating temperature, source voltage or both. As a result, the CPU may be burnt-out before users turn the system in time.

2. If the computer system cannot normally execute the protection software program due to CPU operating temperature, source voltage or both, the CPU may still be burnt-out.

### SUMMARY OF THE INVENTION

The present invention provides a computer system and a method that can more completely prevent a Central Processing Unit (CPU) from burning out. With this invention, the computer system can execute protection mechanism of preventing the CPU from burning out without the need of CPU.

As embodied and broadly described herein, the invention provides a computer system for preventing burn-out of the CPU. The computer system includes a CPU, a Direct Current-to-Direct Current (DC-DC) transformer, a hardware monitor and an ATX power supply. The CPU serves to execute computer programs. The temperature sensor serves to monitor the operating temperature of the CPU. The temperature sensor is attached to a point with a short distance away from the CPU or made as an integral unit of the CPU. The DC-DC transformer is coupled to the CPU for providing a constant source voltage to the CPU. The hardware monitor is coupled to the temperature sensor and the DC-DC transformer for monitoring the operating temperature and the source voltage of the CPU. The ATX power supply is coupled to the hardware monitor and the DC-DC transformer to provide these two units operation power. A control signal, named Post Monitor Power-Trigger Signal, sent from hardware monitor is also connected to the ATX power supply. When either the operating temperature or the source voltage exceeds a permitted range, the hardware monitor sends the post monitor power-triggering signal to the ATX power supply to cut off supply of the operating power.

The invention also provides an alternative mechanism to further enhance the function of preventing burnout of the CPU. It includes a chipset and an alarm system. The chipset is coupled to the CPU, the hardware monitor and the ATX power supply. The chipset provides a control signal, called Pre-Monitor Power-Triggering Signal, to the hardware monitor so that the hardware monitor may activate the Post-Monitor Power-Triggering Signal accordingly. The alarm system is coupled to the hardware monitor for issuing a warning signal to users when the operating temperature or source voltage exceeds a permitted range. The warning signal can be implemented by any acoustic, visual or combination method.

Moreover, The ATX power supply could include a backup power to the hardware monitor. So, when the major or normal power from the ATX power supply is down, the hardware monitor can still work correctly. In addition, for the same reason, the ATX power supply also provides a backup power for the warning system.

The invention is able to further improve the machanism of preventing burnout of the CPU. The hardware monitor integrate a voltage detector. The voltage detector monitors whether the source voltage supplied from the DC-to-DC transformer to the CPU exceeds a permitted voltage range or not.

In brief, the invention provides a hardware monitor that detects any excessive temperature or source voltage of the CPU. If any abnormal circumstances occurred, the operating power will be immediately cuts off via a Post-Monitor Power-Triggering Signal. Since the protection function is able to be fulfilled by the mechanism itself without the existence of CPU and Users,the drawbacks happened in the previous arts can be fixed. Thus, the CPU can get the better protection.

To clearer illustrate the invention and make it easier understand, examples with their diagrams and descriptions in great detail are provided in the following sections.

### BRIEF DESCRIPTION OF THE DRAWINGS

FIG. 1 is a schematic diagram showing a conventional computer system for preventing burn-out of the CPU; and

FIG. 2 is the schematic diagram showing a better computer system for preventing burn-out of the CPU based on the present invention.

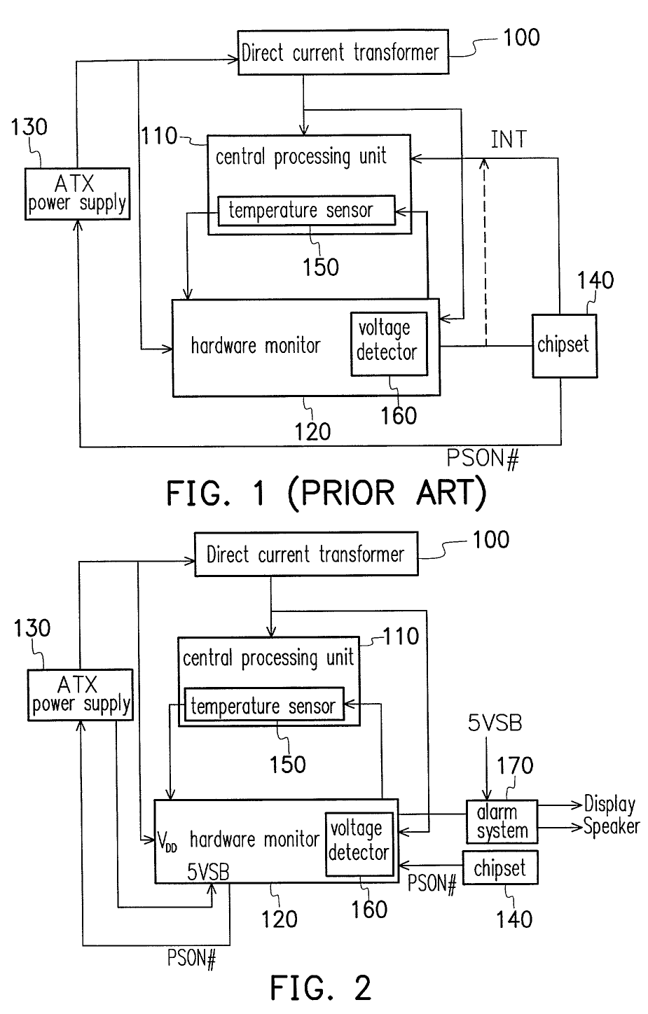

### DESCRIPTION OF THE INVENTION MECHANISM

Reference will now be made in detail to the present preferred mechanism of the invention, examples of which are illustrated in the accompanying drawings. Wherever possible, the same reference numbers are used in the drawings and the description to refer to the same or like parts.

As shown in FIG. 2, the invention mechanism includes a Direct Current to Direct Current (DC-DC) transformer 100, a CPU 110, a hardware monitor 120, an ATX power supply 130, a chipset 140, a temperature sensor 150, a voltage detector 160 and an alarm system 170.

The CPU 110 is at the core of the computer system for executing programs. The temperature sensor 150 for measuring the operating temperature of the CPU 110 is attached within a short distance of the CPU 110. In other words, the temperature sensor 150 is positioned within a range for detecting temperature of the CPU 110. The temperature sensor 150 is preferably integrated in or attached to the underside of the CPU 110 but it can also be attached to other areas. The DC-DC transformer 100 is coupled to the CPU 110. The DC-DC transformer 100 receives power from the ATX power supply 130. After a voltage transformation, the DC-DC transformer 100 provides the CPU 110 a correct source voltage. The hardware monitor 120 is coupled to the temperature sensor 150 and the DC-DC transformer 100 for monitoring the operating temperature and source voltage of the CPU 110. When the operating temperature or source voltage measured by the temperature sensor 150 or the voltage detector 160 is beyond the permissible range, corresponding protection actions are initiated. The ATX power supply 130 is coupled to the hardware monitor 120 and the DC-DC transformer 100. The Post-Monitor Power-Triggering signal is sent from the hardware monitor 120 to the ATX power supply. This signal controls the operating powers supplied to the DC-DC transformer 100 and the hardware monitor 120. And, if either the operating temperature or the source voltage exceeds a permitted range, the hardware monitor 120 sends a Post-Monitor Power-Triggering signal to the ATX power supply 120. Consequently, the ATX power supply cuts off the operating powers of the coupled devices.

Alternatively, the computer system further includes a chipset 140 and an alarm system 170. The chipset 140 is coupled to the CPU 110, the hardware monitor 120 and the ATX power supply 130. The chipset 140 also provides the Pre-Monitor Power-Triggering signal for the hardware monitor 120. Based on the Pre-Monitor Power-Triggering signal, the hardware monitor 120 generates a corresponding post-monitor power-triggering signal The alarm system 170 is coupled to the hardware monitor 120 for issuing a warning as soon as the operating temperature or source voltage exceeds a permitted range. Types of method warning users could be a acoustic signal such as beeping, visual signal such as flashing LED or both.

Also, the ATX power supply 130 provides a backup power for the hardware monitor 120. If the ATX power supply 130 cuts off operating power for any reasons such as malfunction of CPU 110 or when power failure occurs, the hardware monitor 120 can still function properly. Similarly, the ATX power supply 130 also provides backup power to the alarm system.

The hardware monitor 130 further includes a built-in voltage detector 160. The voltage detector 160 serves to monitor the source voltage supplied from the DC-DC transformer 100 to the CPU 110. The voltage detector 160 determines whether the transformed source voltage supplied from the DC-DC transformer 100 is within the permitted voltage range or not.

The chipset 140 submits a pre-monitor power-triggering signal to the hardware monitor 120 and, then, the hardware monitor produces a suitable Post-Monitor Power-Triggering signal. The ATX power supply 130 receives the Post-Monitor Power-Triggering signal and supplies operating power to the DC-DC transformer 100 and the hardware monitor 120. After the DC-DC transformer 100 transforms the operating power, a suitable source voltage would be supplied to the CPU 110. The hardware monitor 120 serves to monitor the operating temperature and source voltage of the CPU 110. So, if for any reasons, the operating temperature or source voltage exceeds a permitted range, the hardware monitor 120 sends out a Post-Monitor Power-Triggering signal to the ATX power supply 130 to cut off supply of the power. In addition, the hardware monitor 120 also activates the alarm system 170 to issue a warning sound or flashing light to alert users.

It will be apparent to those skilled in the art that various modifications and variations can be made to the structure of the present invention without departing from the scope or spirit of the invention. In view of the foregoing, it is intended that the present invention cover modifications and variations of this invention that fall within the scope of the following claims and their equivalents.

What is claimed is:

1. A computer system for preventing burn-out of a Central Processing Unit (CPU), the system comprising:
a CPU for executing computer programs;
a temperature sensor integrated in or adjacent to the CPU for detecting an operating temperature of the CPU;
a Direct Current to Direct Current (DC-DC) transformer coupled to the CPU for supplying a source voltage to the CPU;
a hardware monitor coupled to the temperature sensor and the DC-DC transformer for monitoring the operating temperature and the source voltage of the CPU; and
an ATX power supply coupled to the hardware monitor and the DC-DC transformer for receiving a Post-Monitor Power-Triggering signal from the hardware monitor and providing an operating power to the DC-DC transformer and the hardware monitor, If the operating temperature or the source voltage exceeds a permitted range, the hardware monitor submits a post-monitor power-triggering signal to the ATX power supply and based on this signal, the powers of devices coupled to ATX power will be cut off.

2. The computer system of claim 1, further includes that the chipset provides a pre-monitor signal to the hardware monitor and the hardware monitor, then, produces a post-monitor power-triggering signal to turn down devices' powers.

3. The computer system of claim 1, wherein the ATX power supply further includes a backup power source for the hardware monitor.

4. The computer system of claim 1, wherein the hardware monitor further includes a built-in voltage detector for determining if source voltage provided by the DC-DC transformer exceeds a permitted range or not.

5. The computer system of claim 1, further includes an alarm system controlled by the hardware monitor to issuing warning signals to users.

6. The computer system of claim 5, wherein the ATX power supply further provides a backup power source to the alarm system.

7. The computer system of claim 5, wherein the warning methods include any acoustic or visual ways.

8. The computer system of claim 1, wherein the temperature sensor is fabricated or integrated inside the CPU.

9. A method for preventing CPU burnout in a computer system having a CPU, a sensor, a chipset and an ATX power supply, comprising the following steps:
Providing a hardware monitor coupled to the sensor and the CPU, wherein the hardware monitor constantly measures an operating temperature and a source voltage of the CPU;
Sending a Pre-Monitor Power-Triggering signal from the chipset to the hardware monitor, so that the hardware monitor produces a Post-Monitor Power-Triggering signal to the ATX power supply; and
Sending the Post-Monitor Power-Triggering signal from the hardware monitor to the ATX power supply to shut douw the systm power if the operating temperature or the source voltage exceeds a permitted range.

10. The method of claim 9, further comprising the steps of:
providing an alarm system coupled to the hardware monitor; and
keeping issuing warning signals to alert users if the operating temperature or the source voltage exceeds a permitted range.
